(19) United States
(12) Patent Application Publication
(10) Pub. No.: US 2016/0370809 A1
(43) Pub. Date: Dec. 22, 2016

(54) FLUID FLOW SYSTEM

(71) Applicant: HNI Technologies Inc., Muscatine, IA (US)

(72) Inventors: Charles Stanley Miller, Lake City, MN (US); Suman Minnaganti, St. Paul, MN (US); David Charles Lyons, Red Wing, MN (US); Benjamin Allen Skibsted, Pine Island, MN (US); Louis Lavern Mead, Lake City, MN (US)

(21) Appl. No.: 14/744,878

(22) Filed: Jun. 19, 2015

(51) Int. Cl. G05D 7/06; G05B 15/02; G01F 1/68; G01M 3/28

(52) U.S. Cl. CPC G05D 7/0635; G05D 7/0623; G01M 3/2807; G05B 15/02; G01F 1/68

(57) ABSTRACT

A system including a first element to provide a first parameter value that varies with a first temperature of fluid adjacent the first element, a second element to provide a second parameter value, the first element connected to the second element at an output such that output signals at the output correspond to differences between the first parameter value and the second parameter value, a heater element situated between the first element and the second element to provide heat to the fluid, and a circuit to evaluate the output signals at the output and a threshold value that corresponds to a fluid flow set point and to determine whether flow of the fluid, in at least one direction, across the first element, the heater element, and the second element exceeds the fluid flow set point.

### TECHNICAL FIELD

The present disclosure relates to fluid flow systems and, in particular, to fluid flow sensors for detecting fluid leaks and preventing delayed ignition events.

### BACKGROUND

Systems that incorporate fluid flow are used in a variety of applications, including appliance, instrumentation, metering, and medical applications. These systems may be used in residential and/or commercial applications. Gas appliances, such as stoves, water heaters, fireplaces, and heating, ventilating, and air conditioning (HVAC) systems, often use flammable or explosive gases for heating other fluids or materials. In medical applications, the flow of fluids, such as the flow of oxygen, may be critical to the success of a medical procedure. In each of these systems, it is advantageous to be able to detect fluid leaks, and in systems that use flammable or explosive gases, detecting gas leaks can be a safety issue.

Fluid flow leaks can be detected using a variety of devices, including acoustic sensors and methane gas sensors. In acoustic sensing, a handheld electronic device with an acoustic sensor is used to detect high frequency sound waves along a fluid conduit or pipe. Although effective in detecting gas leaks, acoustic sensing can be cost prohibitive and require special expertise in obtaining reliable results. As to methane gas sensors, they are sometimes used to detect liquefied petroleum gas (LPG) and natural gas (NG). However, methane gas sensors may have sensitivity drift issues when used over a wide range of operating temperatures, and in some applications, multiple sensing points may be needed due to the different densities of LPG and NG. In addition, in some applications, such as in gas fireplace applications, strategic positioning of the sensor(s) would require them to be placed in the firebox, which cannot be achieved by a methane gas sensor.

### SUMMARY

In a first example, a system includes a first element to provide a first parameter value that varies with a first temperature of fluid adjacent the first element, a second element to provide a second parameter value, the first element connected to the second element at an output such that output signals at the output correspond to differences between the first parameter value and the second parameter value, a heater element situated between the first element and the second element to provide heat to the fluid, and a circuit to evaluate the output signals at the output and a threshold value that corresponds to a fluid flow set point and to determine whether flow of the fluid, in at least one direction, across the first element, the heater element, and the second element exceeds the fluid flow set point.

In a second example, a system includes a first element to provide a first parameter that varies with a first temperature of fluid adjacent the first element to measure upstream temperature of the fluid, a second element to provide a second parameter that varies with a second temperature of the fluid adjacent the second element to measure downstream temperature of the fluid, a heater element situated between the first element and the second element to provide heat to the fluid, and a controller to receive signals indicating differences between the first temperature and the second temperature, the controller to determine whether flow of the fluid across the first element, the heater element, and the second element exceeds a fluid flow set point.

In a third example, a method includes sensing a first temperature of a fluid with a first element having a first parameter value that varies with the first temperature of the fluid adjacent the first element, providing a second element having a second parameter value, providing an output signal at an output that corresponds to differences between the first parameter value and the second parameter value, heating a heater element situated between the first element and the second element to provide heat to the fluid, and comparing the output signal at the output to a threshold value that corresponds to a fluid flow set point to determine whether flow of the fluid, in at least one direction, across the first element, the heater element, and the second element exceeds the fluid flow set point.

While multiple embodiments are disclosed, still other embodiments of the disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a diagram illustrating a system that includes a fluid flow sensor for detecting a fluid leak and preventing delayed ignition events, according to embodiments of the disclosure.

FIG. 2 is a diagram illustrating a flow sensor coupled to the control circuit, according to embodiments of the disclosure.

FIG. 3 is a diagram illustrating a side view of a layout of the flow sensor, according to embodiments of the disclosure.

FIG. 4 is a diagram illustrating a microcontroller that is part of the control circuit, according to embodiments of the disclosure.

FIG. 5 is a diagram illustrating a differential amplifier that is part of the control circuit, according to embodiments of the disclosure.

FIG. 6 is a diagram illustrating a flow sensor that includes four sensor elements, a heater element, and a control circuit, according to embodiments of the disclosure.

FIG. 7 is a diagram illustrating a top view of a layout of the flow sensor, according to embodiments of the disclosure.

FIG. 8 is a diagram illustrating a top view of a layout of a flow sensor, according to embodiments of the disclosure.

FIG. 9 is a diagram illustrating a top view of a layout of a flow sensor, according to embodiments of the disclosure.

FIG. 10 is a diagram illustrating a flow sensor that includes a baffle, according to embodiments of the disclosure.

FIG. 11 is a method of detecting fluid flow in a flow sensor, according to embodiments of the disclosure.

### DETAILED DESCRIPTION

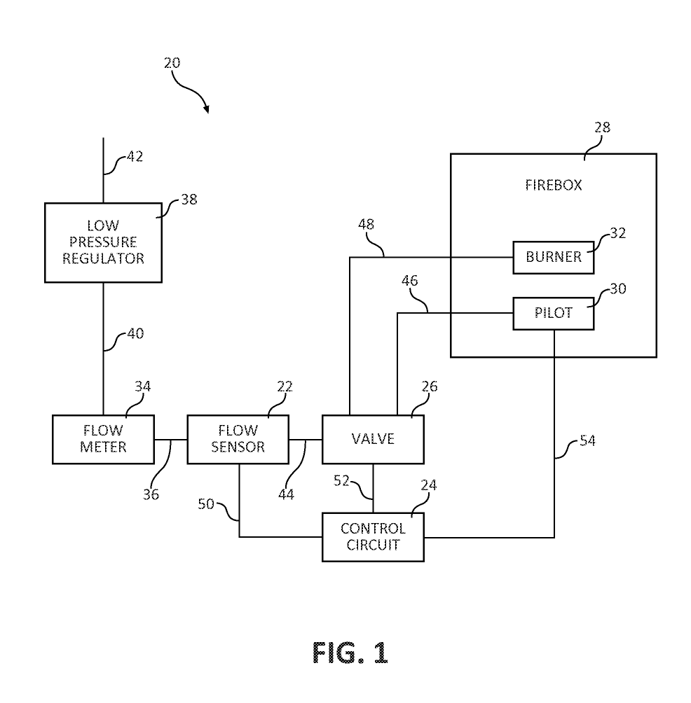

FIG. 1 is a diagram illustrating a system 20 that includes a fluid flow sensor 22 for detecting a fluid leak and preventing delayed ignition events, according to embodiments of the disclosure. The system 20 is a fireplace and the fluid used in the fireplace is gas, such as LPG or NG. In other embodiments, the system 20 can be a different type of system, such as a stove, a water heater, or an HVAC system, and the fluid can be a non-gaseous fluid, such as a liquid. Also, in other embodiments, the fluid flow sensor 22 can be used in other applications, such as other appliance, instrumentation, metering, and medical applications.

The system 20 includes the flow sensor 22, a control circuit 24, and a gas control valve 26, situated outside a fireplace firebox 28. The system 20 also includes a pilot 30 and a burner 32, situated inside the firebox 28. In some embodiments, one or more of the flow sensor 22, the control circuit 24, and the control valve 26 can be situated inside the firebox 28.

The flow sensor 22 is fluidically coupled to a flow meter 34 via a fluid line 36 and the flow meter 34 is fluidically coupled to a low pressure regulator 38 via a fluid line 40, where the low pressure regulator 38 receives the main fluid line or, in this example, the main gas line 42. The flow sensor 22 is also fluidically coupled to the control valve 26 via valve fluid line 44 and the control valve 26 is fluidically coupled to the pilot 30 via pilot fluid line 46 and to the burner 32 via burner fluid line 48.

In this configuration, with the control valve 26 switched to an open position to allow gas to flow to the pilot 30 and/or the burner 32, gas flows from the main line 42 through the low pressure regulator 38, the flow meter 34, the flow sensor 22, and the control valve 26 to the pilot 30 and/or the burner 32.

With the control valve 26 switched to a closed position to stop or prevent gas flow to both the pilot 30 and the burner 32, gas does not flow through the low pressure regulator 38, the flow meter 34, the flow sensor 22, or the control valve 26. Instead, no gas flows through the system 20, unless the system 20 has a gas leak. Thus, if the flow sensor 22 detects gas flow that exceeds a gas flow set point with the control valve 26 closed, the system 20 has a gas leak and the control valve 26 is automatically shut down to prevent the control valve 26 from opening and allowing gas to flow to the pilot 30 and/or the burner 32.

The flow sensor 22 is communicatively coupled to the control circuit 24 via communications path 50 and the control circuit 24 is communicatively coupled to the control valve 26 via valve communications path 52. Also, in some embodiments, the control circuit 24 is communicatively coupled to the pilot 30 via pilot communications path 54. In some embodiments, one or more of the communications paths 50, 52, and 54 includes a conductor. In some embodiments, one or more of the communications paths 50, 52, and 54 includes wireless communications.

The flow sensor 22 provides output signals that indicate the magnitude of fluid flow through the flow sensor 22. These output signals are received by the control circuit 24 via communications path 50 and the control circuit 24 evaluates the received output signals and a threshold value that corresponds to a fluid flow set point to determine whether flow of the fluid through the flow sensor 22 exceeds the fluid flow set point. If the flow of the fluid through the flow sensor 22 exceeds the fluid flow set point with the control valve 26 closed, the control circuit 24 provides a valve control signal to the control valve 26 via communications path 52, which shuts down the control valve 26 to prevent the control valve 26 from opening and allowing gas to flow to the pilot 30 and/or the burner 32. Also, in at least some embodiments, if the flow of the fluid exceeds the fluid flow set point with the control valve 26 closed, the control circuit 24 provides a pilot control signal to the pilot 30 via communications path 54 to prevent sparking, which is otherwise used to light the gas pilot light for ignition of the burner 32. In some embodiments, the output signals from the flow sensor 22 are voltages. In some embodiments, the output signals from the flow sensor 22 are currents. In some embodiments, the functions of the control circuit 24 are embedded in the control valve 26.

Also, in some embodiments, the control circuit 24 provides at least one signal that indicates whether the fluid flow set point has been exceeded to one or both of the control valve 26 and a controller, which receive the at least one signal and provide a system shut-off signal to lock or shut down the control valve 26 to prevent the control valve 26 from opening and allowing gas to flow to the pilot 30 and/or the burner 32 and, in at least some embodiments, to prevent sparking, which is otherwise used to light the gas pilot light for ignition of the burner 32.

In operation, with the control valve 26 closed, the flow sensor 22 provides an output signal that indicates the magnitude of the fluid flow through the flow sensor 22. The control circuit 24 receives the output signal and evaluates the output signal in relation to the threshold value that corresponds to a fluid flow set point to determine whether flow of the fluid through the flow sensor 22 exceeds the fluid flow set point. If the gas flow through the flow sensor 22 is below the fluid flow set point, the control circuit 24 opens the control valve 26 to allow gas to flow to the pilot 30. The control circuit 24 and the pilot 30 activate a sparker that provides a spark to light the gas pilot light of the pilot 30. After the flame of the pilot light has been established, the sparker is shut off and the control circuit 24 controls the control valve 26 to open the gas flow to the burner 32. The pilot light lights the burner 32.

If the flow of the fluid through the flow sensor 22 exceeds the fluid flow set point with the control valve 26 closed, the control circuit 24 provides a valve control signal to the control valve 26 to shut down the control valve 26. This locks out the control valve 26 and prevents gas from flowing to both the pilot 30 and the burner 32. Also, in at least some embodiments, if the flow of the fluid exceeds the fluid flow set point, the control circuit 24 provides a pilot control signal to the pilot 30 to prevent sparking

By detecting gas leaks and preventing gas flow to the pilot 30 and the burner 32 and, in at least some embodiments, by preventing sparking, the system 20 prevents delayed ignition events, fires, and explosions, which increases safety.

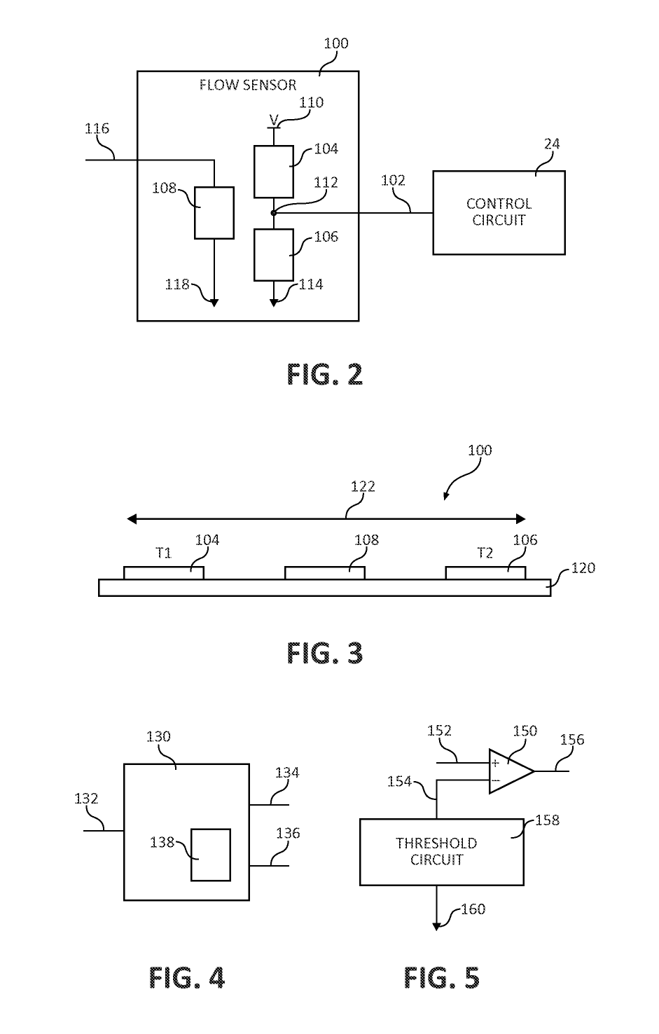

FIG. 2 is a diagram illustrating a flow sensor 100 coupled to the control circuit 24, according to embodiments of the disclosure. The flow sensor 100 is communicatively coupled to the control circuit 24 via communications path 102. In some embodiments, the flow sensor 100 is used in place of the flow sensor 22 in system 20 of FIG. 1. In some embodiments, the flow sensor 100 is similar to the flow sensor 22.

The flow sensor 100 includes a first element 104, a second element 106, and a heater element 108. One side of the first element 104 is electrically coupled to power at 110 and the other side of the first element 104 is electrically coupled to one side of the second element 106 at output 112. The other side of the second element 106 is electrically coupled to a reference, such as ground, at 114, and the output 112 is electrically coupled to the control circuit 24 via communications path 102. In some embodiments, the power at 110 is a constant DC power supply voltage. Also, in other embodiments, the positions of the first element 104 and the second element 106 can be switched around, such that one side of the second element 106 is electrically coupled to power at 110 and the other side of the second element 106 is electrically coupled to one side of the first element 104 at output 112 and the other side of the first element 104 is electrically coupled to the reference at 114.

As to the heater element 108, one side of the heater element 108 is electrically coupled to receive heater control signals at 116 and the other side of the heater element 108 is electrically coupled to a reference, such as ground, at 118. In some embodiments, the heater element is a resistive heater element. In some embodiments, the heater element 108 receives the heater control signals at 116 from the control circuit 24. In some embodiments, the heater control signals are pulse width modulated (PWM) signals. Also, in some embodiments, the reference at 114 and the reference at 118 are the same.

FIG. 3 is a diagram illustrating a side view of a layout of the flow sensor 100, according to embodiments of the disclosure. The flow sensor 100 includes a substrate 120, such as a circuit board, with the first element 104 attached to the substrate 120 and situated to the left on the substrate 120 and the second element 106 attached to the substrate 120 and situated to the right on the substrate 120. The heater element 108 is situated between the first element 104 and the second element 106, where the heater element 108 provides heat to the fluid above the first element 104, the heater element 108, and the second element 106.

The flow sensor 100 is situated in a system, such as system 20, to detect fluid flow and to determine whether the system 20 has a fluid leak. The fluid flows through the flow sensor 100 from the left to the right or from the right to the left as indicated by arrow 122. If the system does not have a fluid leak, the fluid does not flow through the flow sensor 100, but is stagnant in the flow sensor 100. If the system does have a fluid leak, the fluid flows from left to right or from right to left through the flow sensor 100.

If the system has a fluid leak, the fluid enters the flow sensor 100 having an ambient temperature and passes over the heater element 108, which heats the fluid flowing through the flow sensor 100. In some embodiments, a predetermined temperature difference is maintained between the ambient temperature of the fluid and the temperature of the heater element 108. In some embodiments, a predetermined temperature difference is maintained between the ambient temperature of the fluid and the temperature of the fluid adjacent the heater element 108. In some embodiments, the predetermined temperature difference is in a temperature of from 30 to 40 degrees Fahrenheit.

Referring to FIGS. 2 and 3, the first element 104 provides a first parameter value that varies with a temperature of the fluid adjacent the first element 104. In some embodiments, the first element 104 is a thermistor that provides a resistance value that varies with and corresponds to the temperature of the fluid, such as gas and/or air, near the first element 104. In some embodiments, the first element 104 is a 100 kilo-ohm thermistor. In some embodiments, the first element 104 is a thermistor having a 5% tolerance.

The second element 106 provides a second parameter value. In some embodiments, the second parameter value is a fixed value, such as a fixed resistance value. In some embodiments, the second parameter value varies with a temperature of the fluid adjacent the second element 106. In some embodiments, the second element 106 is a thermistor that provides a resistance value that varies with and corresponds to the temperature of the fluid, such as gas and/or air, near the second element 106. In some embodiments, the second element 106 is a 100 kilo-ohm thermistor. In some embodiments, the second element 106 is a thermistor having a 5% tolerance.

The output signal, which can be a voltage or a current, at the output 112 corresponds to the difference between the first parameter value and the second parameter value. If only one of the first and second elements 104 and 106 provides a parameter value that varies with the temperature of the liquid adjacent or near the element, the output signal at the output 112 corresponds to the temperature of the fluid adjacent the element that provides the parameter value that varies with temperature. If both the first and second elements 104 and 106 provide parameter values that vary with the temperature of the liquid adjacent them, the output signal at the output 112 corresponds to the difference in temperature of the fluid adjacent the first element 104 and the second element 106. In some embodiments, the output signals are voltages. In some embodiments, the output signals are currents.

In one example operation, the heater element 108 is turned on and the temperature of the heater element 108 is raised to a predetermined value or range of values. If the fluid is stagnant in the flow sensor 100, the temperature T1 of the fluid adjacent the first element 104 and the temperature T2 of the fluid adjacent the second element 106 increase to known values or range of values. At these temperatures, each of the first and second elements 104 and 106 provides a parameter value, such as a resistance value, that lies in a known parameter value range and the output signal at the output 112 stabilizes to a known output signal value range.

In contrast, if the system has a fluid leak and the fluid flows through the flow sensor 100, from left to right or from right to left, one or both of the temperatures T1 and T2 will be different from the stagnant temperature values and they will correspond to the fluid flow. In this situation, the first element 104 that has a parameter value that varies with the temperature T1 provides a parameter value that corresponds to the temperature Tl, and the second element 106 either provides a relatively constant parameter value or if the second element 106 has a parameter value that varies with the temperature T2, the second element 106 provides a parameter value that corresponds to the temperature T2.

If the fluid flows through the fluid sensor 100 from left to right, first across the first element 104, then across the heater element 108, and then across the second element 106, the temperature T1 of the fluid adjacent the first element 104 is less than the temperature of the fluid adjacent the heater element 108 and less than the temperature T2 of the fluid adjacent the second element 106. Also, since the ambient temperature of the fluid entering the flow sensor 100 is less than the temperature of the heater element 108, the temperature T1 is lower than its stagnant temperature value.

If the fluid flows through the fluid sensor 100 from right to left, first across the second element 106, then across the heater element 108, and then across the first element 104, the temperature T2 of the fluid adjacent the second element 106 is less than the temperature of the fluid adjacent the heater element 108 and less than the temperature T1 of the fluid adjacent the first element 104. Also, since the ambient temperature of the fluid entering the flow sensor 100 is less than the temperature of the heater element 108, the temperature T2 is lower than its stagnant temperature value.

If only one of the first and second elements 104 and 106 provides a parameter value that varies with the temperature of the liquid adjacent or near the element, the output signal at the output 112 corresponds to the temperature of the fluid adjacent the element that provides the parameter value that varies with temperature. If both the first and second elements 104 and 106 provide parameter values that vary with the temperature of the liquid adjacent them, the output signal at the output 112 corresponds to the difference in the temperatures T1 and T2.

The control circuit 24 receives the output signal at the output 112 and evaluates the received output signal in relation to a threshold value that corresponds to a fluid flow set point. Based on this evaluation, the control circuit 24 determines whether flow of the fluid through the flow sensor 100 exceeds the fluid flow set point. In some embodiments, the control circuit 24 evaluates the received output signal in relation to multiple threshold values that correspond to multiple fluid flow set points. In some embodiments, the control circuit 24 determines that flow of the fluid through the flow sensor 100 exceeds a fluid flow set point if the output signal at the output 112 is less than a threshold value. In some embodiments, the control circuit 24 determines that flow of the fluid through the flow sensor 100 exceeds a fluid flow set point if the output signal at the output 112 is greater than a threshold value.

If the control circuit 24 determines that the fluid flow through the flow sensor 100 exceeds the fluid flow set point, the control circuit 24 provides the valve control signal to the control valve 26 to shut down the control valve 26. This locks out the control valve 26 and prevents gas from flowing to the pilot 30 and the burner 32. Also, in at least some embodiments, the control circuit 24 provides a pilot control signal to the pilot 30 to prevent sparking.

FIG. 4 is a diagram illustrating a microcontroller 130 that is part of the control circuit 24, according to embodiments of the disclosure. The microcontroller 130 includes an input 132 that is electrically coupled to the output 112 for receiving the output signal at the output 112, which herein includes receiving a value that represents the output signal at the output 112. Also, the microcontroller 130 includes a first output 134 that is electrically coupled to the control valve 26 and, at least optionally, a second output 136 electrically coupled to the pilot 30. The microcontroller 130 also includes memory 138 that stores software and/or the microcontroller 130 has access to other memory that stores software, which the microcontroller 130 executes to provide the functions of the control circuit 24.

The microcontroller 130 receives the output signal at the output 112 at input 132 and evaluates the received output signal in relation to a threshold value that can be stored in memory 138. The threshold value corresponds to a fluid flow set point. The microcontroller 130 compares the received output signal to the threshold value and, based on this evaluation, determines whether flow of the fluid through the flow sensor 100 exceeds the fluid flow set point. In some embodiments, the microcontroller 130 determines whether flow of the fluid, in either direction from left to right or from right to left, through the flow sensor 100 exceeds the fluid flow set point.

If the microcontroller 130 determines that the flow of fluid through the flow sensor 100 exceeds a fluid flow set point, the microcontroller 130 provides the valve control signal at 134 to the control valve 26 to shut down the control valve 26 and, in at least some embodiments, the microcontroller 130 provides the pilot control signal at 136 to the pilot 30 to prevent sparking.

FIG. 5 is a diagram illustrating a differential amplifier 150 that is part of the control circuit 24, according to embodiments of the disclosure. The differential amplifier 150 includes differential inputs 152 and 154 and an amplifier output 156. The differential input 152 is electrically coupled to the output 112 and the differential input 154 is electrically coupled to a threshold circuit 158 that is electrically coupled to a reference, such as ground, at 160. The threshold circuit 158 provides one or more threshold values that correspond to fluid flow set points.

In operation, the differential amplifier 150 receives the output signal, such as a voltage, at the output 112 at differential input 152 and a threshold value from the threshold circuit 158 at differential input 154. The differential amplifier 150 provides an output voltage at the amplifier output 156, which corresponds to the voltage difference between the inputs 152 and 154. In some embodiments, the amplifier output 156 is electrically coupled to circuitry, such as comparator circuitry and/or a microcontroller, that determines whether flow of the fluid through the flow sensor 100 exceeds the fluid flow set point and that provides the valve control signal to the control valve 26 and/or the pilot control signal to the pilot 30 to prevent sparking

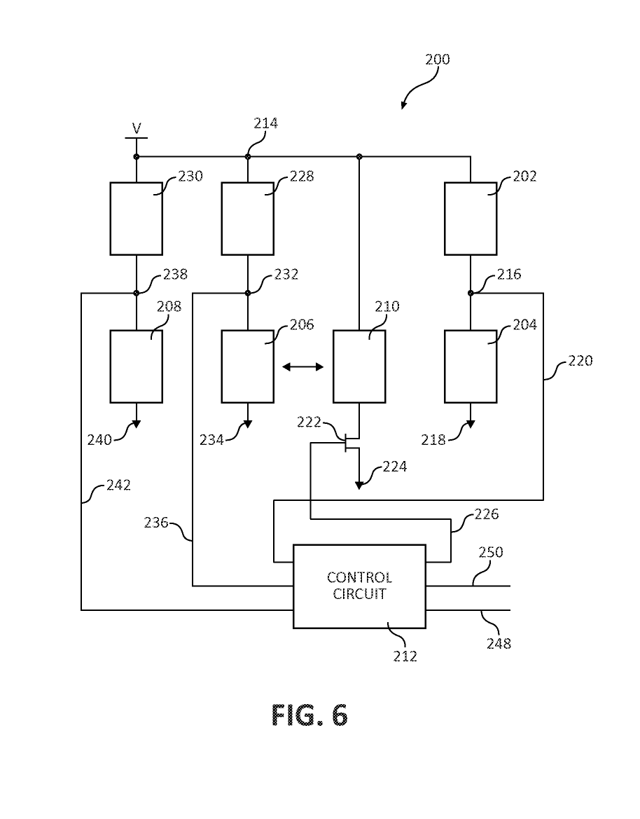

FIG. 6 is a diagram illustrating a flow sensor 200 that includes four sensor elements 202, 204, 206, and 208, a heater element 210, and a control circuit 212, according to embodiments of the disclosure. In some embodiments, the flow sensor 200 and the control circuit 212 are used in place of the flow sensor 22 and the control circuit 24 in system 20 of FIG. 1. In some embodiments, the flow sensor 200 is similar to the flow sensor 22. In some embodiments, the control circuit 212 is similar to the control circuit 24. In some embodiments, the control circuit 212 includes a microcontroller.

The first element 202 and the second element 204 are used for determining whether the fluid is flowing through the flow sensor 200, as described above. The third element 206 is for sensing the temperature of the heater element 210 by sensing the temperature of the fluid adjacent the heater element 210. The fourth element 208 is for sensing the ambient temperature of the fluid. Optionally, in some embodiments, the fourth element 208 is not included and the third element 206 is used for both sensing the ambient temperature of the fluid prior to the fluid being heated by the heater element 210 and for sensing the temperature of the heater element 210. In some embodiments, the third element 206 is not included and the heater element 210 provides a signal to the control circuit 212 that indicates the temperature of the heater element 210. In some embodiments, the third element 206 is not included and the heater element 210 provides a heater parameter, such as a resistance, to the control circuit 212 that indicates the temperature of the heater element 210.

One side of the first element 202 is electrically coupled to power at 214 and the other side of the first element 202 is electrically coupled to one side of the second element 204 at first output 216. The other side of the second element 204 is electrically coupled to a reference, such as ground, at 218, and the first output 216 is communicatively coupled to the control circuit 212 via communications path 220. In some embodiments, the power at 214 is a constant DC power supply voltage. Also, in other embodiments, the positions of the first element 202 and the second element 204 can be switched around, such that one side of the second element 204 is electrically coupled to power at 214 and the other side of the second element 204 is electrically coupled to one side of the first element 202 at first output 216 and the other side of the first element 202 is electrically coupled to the reference at 218.

As to the heater element 210, one side of the heater element 210 is electrically coupled to power at 214 and the other side of the heater element 210 is electrically coupled to one side of the drain-source path of a metal oxide semiconductor field effect transistor (MOSFET) 222. The other side of the drain-source path of the MOSFET 222 is electrically coupled to a reference, such as ground, 224. The gate of the MOSFET 222 is communicatively coupled to the control circuit 212 via communications path 226 to receive heater control signals from the control circuit 212. In some embodiments, the heater element 210 is a resistive heater element. In some embodiments, the heater control signals are pulse width modulated (PWM) signals.

The flow sensor also includes a first resistor 228 and a second resistor 230. One side of the first resistor 228 is electrically coupled to power at 214 and the other side of the first resistor 228 is electrically coupled to one side of the third element 206 at second output 232. The other side of the third element 206 is electrically coupled to a reference, such as ground, at 234, and the second output 232 is communicatively coupled to the control circuit 212 via communications path 236. Also, one side of the second resistor 230 is electrically coupled to power at 214 and the other side of the second resistor 230 is electrically coupled to one side of the fourth element 208 at third output 238. The other side of the fourth element 208 is electrically coupled to a reference, such as ground, at 240, and the third output 238 is communicatively coupled to the control circuit 212 via communications path 242. In some embodiments, two or more of the references at 218, 224, 234, and 240 are the same reference.

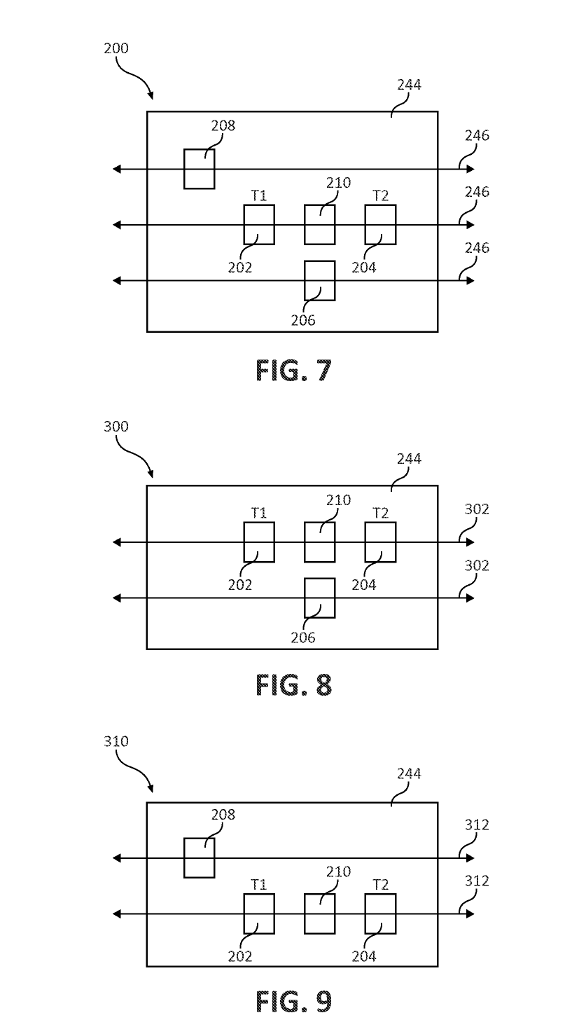

FIG. 7 is a diagram illustrating a top view of a layout of the flow sensor 200, according to embodiments of the disclosure. The flow sensor 200 includes a substrate 244, such as a circuit board, with the first element 202 attached to the substrate 244 and situated to the left on the substrate 244 and the second element 204 attached to the substrate 244 and situated to the right on the substrate 244. The heater element 210 is attached to the substrate 244 and situated between the first element 202 and the second element 204, where the heater element 210 provides heat to the fluid above the first element 202, the heater element 210, and the second element 204.

The third element 206 is situated in the lower portion of the substrate 244 and next to the heater element 210 for sensing the temperature of the heater element 210 by sensing the temperature of the fluid adjacent the heater element 210. In other embodiments, the third element 206 is not included and the heater element 210 provides an indication of the temperature of the heater element 210 to the control circuit 212.

The fourth element 208 is situated in the upper portion of the substrate 244 and away from the heater element 210 for sensing the ambient temperature of the fluid in the flow sensor 200. In other embodiments, the fourth element 208 is not included and the third element 206 is used to determine the ambient temperature of the fluid prior to the heater element 210 being activated.

The flow sensor 200 is situated in a system, such as system 20, to detect fluid flow and to determine whether the system 20 has a fluid leak. The fluid flows through the flow sensor 200 from the left to the right or from the right to the left as indicated by arrows 246. If the system does not have a fluid leak, the fluid does not flow through the flow sensor 200, but is stagnant in the flow sensor 200. If the system does have a fluid leak, the fluid flows from left to right or from right to left through the flow sensor 200.

If the system has a fluid leak, the fluid enters the flow sensor 200 having an ambient temperature that is sensed by the fourth element 208 or, optionally, sensed by the third element 206 prior to activating the heater element 210. After the heater element 210 is activated, the temperature of the fluid adjacent the heater element 210 is sensed by the third element 206 or, optionally, the heater element 210 provides a signal or a parameter, such as resistance, to the control circuit that indicates the temperature of the heater element 210. In some embodiments, a predetermined temperature difference is maintained between the ambient temperature of the fluid and the temperature of the heater element 210. In some embodiments, a predetermined temperature difference is maintained between the ambient temperature of the fluid and the temperature of the fluid adjacent the heater element 210. In some embodiments, the predetermined temperature difference is in a temperature of from 30 to 40 degrees Fahrenheit.

Referring to FIGS. 6 and 7, the first element 202 provides a first parameter value that varies with a temperature of the fluid adjacent the first element 202. In some embodiments, the first element 202 is a thermistor that provides a resistance value that varies with and corresponds to the temperature of the fluid, such as gas and/or air, near the first element 202. In some embodiments, the first element 202 is a 100 kilo-ohm thermistor. In some embodiments, the first element 202 is a thermistor having a 5% tolerance.

The second element 204 provides a second parameter value. In some embodiments, the second parameter value is a fixed value, such as a fixed resistance value. In some embodiments, the second parameter value varies with a temperature of the fluid adjacent the second element 204. In some embodiments, the second element 204 is a thermistor that provides a resistance value that varies with and corresponds to the temperature of the fluid, such as gas and/or air, near the second element 204. In some embodiments, the second element 204 is a 100 kilo-ohm thermistor. In some embodiments, the second element 204 is a thermistor having a 5% tolerance.

The first output signal, which can be a voltage or a current, at the first output 216 corresponds to the difference between the first parameter value and the second parameter value. If only one of the first and second elements 202 and 204 provides a parameter value that varies with the temperature of the liquid adjacent or near the element, the first output signal at the first output 216 corresponds to the temperature of the fluid adjacent the element that provides the parameter value that varies with temperature. If both the first and second elements 202 and 204 provide parameter values that vary with the temperature of the liquid adjacent them, the first output signal at the first output 216 corresponds to the difference in temperature of the fluid adjacent the first element 202 and the second element 204. In some embodiments, the first output signals are voltages. In some embodiments, the first output signals are currents.

The third element 206 provides a third parameter value that varies with a temperature of the fluid adjacent the third element 206, and the first resistor 228 provides a fixed resistance value. The third element 206 senses the temperature of the fluid adjacent the heater element 210 to determine the temperature of the heater element 210. In some embodiments, the third element 206 is a thermistor that provides a resistance value that varies with and corresponds to the temperature of the fluid, such as gas and/or air, near the third element 206. In some embodiments, the third element 206 is a 100 kilo-ohm thermistor. In some embodiments, the third element 206 is a thermistor having a 5% tolerance.

The second output signal, which can be a voltage or a current, at the second output 232 corresponds to the difference between the third parameter value and the fixed resistance value of the first resistor 228. The third parameter value varies with the temperature of the liquid adjacent or near the third element 206 such that the second output signal at the second output 232 corresponds to the temperature of the fluid adjacent the third element 206. In some embodiments, the third element 206 and the first resistor 228 are not included and the heater element 210 provides an indication of the temperature of the heater element 210 to the control circuit 212. In some embodiments, the second output signals are voltages. In some embodiments, the second output signals are currents.

The fourth element 208 provides a fourth parameter value that varies with a temperature of the fluid adjacent the fourth element 208, and the second resistor 230 provides a fixed resistance value. The fourth element 208 senses the ambient temperature of the fluid. In some embodiments, the fourth element 208 is a thermistor that provides a resistance value that varies with and corresponds to the temperature of the fluid, such as gas and/or air, near the fourth element 208. In some embodiments, the fourth element 208 is a 100 kilo-ohm thermistor. In some embodiments, the fourth element 208 is a thermistor having a 5% tolerance.

The third output signal, which can be a voltage or a current, at the third output 238 corresponds to the difference between the fourth parameter value and the fixed resistance value of the second resistor 230. The fourth parameter value varies with the temperature of the liquid adjacent or near the fourth element 208 such that the third output signal at the third output 238 corresponds to the temperature of the fluid adjacent the fourth element 208. In other embodiments, the fourth element 208 and the second resistor 230 are not included and the third element 206 with the first resistor 228 senses the ambient temperature and provides an ambient temperature signal to the control circuit 212 via the second output 232. In some embodiments, the third output signals are voltages. In some embodiments, the third output signals are currents.

In one example operation, the fourth element 208 senses the ambient temperature of the fluid and provides a signal from the third output 238 to the control circuit 212 via communications path 242. The signal indicates the ambient temperature of the fluid, such as the ambient temperature of the fluid prior to any heating of the fluid by the heater element 210. In some embodiments, the fourth element 208 and the second resistor 230 are not included and the third element 206 and the first resistor 228 sense the ambient temperature of the fluid and provide a signal from the second output 232 to the control circuit 212 via communications path 236, which indicates the ambient temperature of the fluid, such as the ambient temperature of the fluid prior to any heating of the fluid by the heater element 210.

The control circuit 212 activates the heater element 210 by sending PWM signals to the gate of the MOSFET 222, which increases the temperature of the heater element 210 and the fluid adjacent the heater element 210. The third element 206 senses the temperature of the fluid adjacent the heater element 210 and provides a signal from the second output 232 to the control circuit 212 via communications path 236. The signal indicates the temperature of the fluid adjacent the heater element 210 and is used to determine the temperature of the heater element 210. In some embodiments, the third element 206 and the first resistor 228 are not included and the heater element 210 provides an indication of the temperature of the heater element 210 to the control circuit 212.

The control circuit 212 receives the signals that indicate the ambient temperature of the fluid and the temperature of the heater element 210 or the temperature of the fluid adjacent the heater element 210. The control circuit 212 increases the temperature of the heater element 210 to a predetermined value or range of values above the ambient temperature. In some embodiments, the predetermined temperature difference is a temperature of from 30 to 40 degrees Fahrenheit.

If the fluid is stagnant in the flow sensor 200, the temperature T1 of the fluid adjacent the first element 202 and the temperature T2 of the fluid adjacent the second element 204 increase to a known value or range of values. The temperatures T1 and T2 are substantially the same. At these temperatures, each of the first and second elements 202 and 204 provide a parameter value, such as a resistance value, that lies in a known parameter value range and the first output signal at the first output 216 stabilizes to a known value range.

In contrast, if the system has a fluid leak and the fluid flows through the flow sensor 200, from left to right or from right to left, one or both of the temperatures T1 and T2 will be different from the stagnant temperature value and they will correspond to the fluid flow. In this situation, the first element 202 that has a parameter value that varies with the temperature T1 provides a parameter value that corresponds to the temperature T1, and the second element 204 either provides a relatively constant parameter value or if the second element 204 has a parameter value that varies with the temperature T2, the second element 204 provides a parameter value that corresponds to the temperature T2.

If the fluid flows through the fluid sensor 200 from left to right, first across the first element 202, then across the heater element 210, and then across the second element 204, the temperature T1 of the fluid adjacent the first element 202 is less than the temperature of the fluid adjacent the heater element 210 and less than the temperature T2 of the fluid adjacent the second element 204. Also, since the ambient temperature of the fluid entering the flow sensor 200 is less than the temperature of the heater element 210, the temperature T1 is lower than its stagnant temperature value.

If the fluid flows through the fluid sensor 200 from right to left, first across the second element 204, then across the heater element 210, and then across the first element 202, the temperature T2 of the fluid adjacent the second element 204 is less than the temperature of the fluid adjacent the heater element 210 and less than the temperature T1 of the fluid adjacent the first element 202. Also, since the ambient temperature of the fluid entering the flow sensor 200 is less than the temperature of the heater element 210, the temperature T2 is lower than its stagnant temperature value.

If only one of the first and second elements 202 and 204 provides a parameter value that varies with the temperature of the liquid adjacent or near the element, the first output signal at the first output 216 corresponds to the temperature of the fluid adjacent the element that provides the parameter value that varies with temperature. If both the first and second elements 202 and 204 provide parameter values that vary with the temperature of the liquid adjacent them, the first output signal at the first output 216 corresponds to the difference in the temperatures T1 and T2.

The control circuit 212 receives the first output signal at the first output 216 via communications path 220 and evaluates the received output signal in relation to a threshold value that corresponds to a fluid flow set point. Based on this evaluation, the control circuit 212 determines whether flow of the fluid through the flow sensor 200 exceeds the fluid flow set point. In some embodiments, the control circuit 212 evaluates the received output signal in relation to multiple threshold values that correspond to multiple fluid flow set points. In some embodiments, the control circuit 212 determines that flow of the fluid through the flow sensor 200 exceeds a fluid flow set point if the output signal at the first output 216 is less than a threshold value. In some embodiments, the control circuit 212 determines that flow of the fluid through the flow sensor 200 exceeds a fluid flow set point if the output signal at the first output 216 is greater than a threshold value.

If the control circuit 212 determines that the fluid flow through the flow sensor 200 exceeds the fluid flow set point, the control circuit 212 provides the valve control signal via communications path 248 to the control valve 26 to shut down the control valve 26. This locks out the control valve 26 and prevents gas from flowing to the pilot 30 and the burner 32. Also, in at least some embodiments, the control circuit 212 provides a pilot control signal via communications path 250 to the pilot 30 to prevent sparking

FIG. 8 is a diagram illustrating a top view of a layout of a flow sensor 300, according to embodiments of the disclosure. The flow sensor 300 is similar to the flow sensor 200, except the flow sensor 300 does not include the fourth element 208 and the second resistor 230. Instead, the third element 206 and the first resistor 228 sense the ambient temperature of the fluid and provide a signal from the second output 232 to the control circuit 212, which indicates the ambient temperature of the fluid, such as the ambient temperature of the fluid prior to any heating of the fluid by the heater element 210.

The flow sensor 300 includes the substrate 244 with the first element 202 attached to the substrate 244 and situated to the left on the substrate 244 and the second element 204 attached to the substrate 244 and situated to the right on the substrate 244. The heater element 210 is attached to the substrate 244 and situated between the first element 202 and the second element 204, where the heater element 210 provides heat to the fluid above the first element 202, the heater element 210, and the second element 204.

The third element 206 is situated in the lower portion of the substrate 244 and next to the heater element 210 for sensing the ambient temperature of the fluid and for sensing the temperature of the heater element 210 by sensing the temperature of the fluid adjacent the heater element 210.

The flow sensor 300 is situated in a system, such as system 20, to detect fluid flow and to determine whether the system 20 has a fluid leak. The fluid flows through the flow sensor 300 from the left to the right or from the right to the left as indicated by arrows 302. If the system does not have a fluid leak, the fluid does not flow through the flow sensor 300, but is stagnant in the flow sensor 300. If the system does have a fluid leak, the fluid flows from left to right or from right to left through the flow sensor 300.

If the system has a fluid leak, the fluid enters the flow sensor 300 having an ambient temperature that is sensed by the third element 206 prior to activating the heater element 210. After the heater element 210 is activated, the third element 206 senses the temperature of the fluid adjacent the heater element 210 to determine the temperature of the heater element 210. In some embodiments, the heater element 210 provides an indication of the temperature of the heater element 210 to the control circuit 212.

In some embodiments, a predetermined temperature difference is maintained between the ambient temperature of the fluid and the temperature of the heater element 210. In some embodiments, a predetermined temperature difference is maintained between the ambient temperature of the fluid and the temperature of the fluid adjacent the heater element 210. In some embodiments, the predetermined temperature difference is in a temperature of from 30 to 40 degrees Fahrenheit.

In one example operation, the third element 206 and the first resistor 228 sense the ambient temperature of the fluid and provide a signal from the second output 232 to the control circuit 212 via communications path 236. This signal indicates the ambient temperature of the fluid, such as the ambient temperature of the fluid prior to any heating of the fluid by the heater element 210.

The control circuit 212 activates the heater element 210 by sending PWM signals to the gate of the MOSFET 222, which increases the temperature of the heater element 210 and the fluid adjacent the heater element 210. The third element 206 senses the temperature of the fluid adjacent the heater element 210 and provides a signal from the second output 232 to the control circuit 212, which indicates the temperature of the fluid adjacent the heater element 210 and is used to determine the temperature of the heater element 210. In some embodiments, the heater element 210 provides an indication of the temperature of the heater element 210 to the control circuit 212.

The control circuit 212 receives the signals that indicate the ambient temperature of the fluid and the temperature of the heater element 210 or the temperature of the fluid adjacent the heater element 210. The control circuit 212 increases the temperature of the heater element 210 to a predetermined value or range of values above the ambient temperature. In some embodiments, the predetermined temperature difference is in a temperature range of from 30 to 40 degrees Fahrenheit. The process of determining fluid flow continues as previously described in relation to the flow sensor 200.

FIG. 9 is a diagram illustrating a top view of a layout of a flow sensor 310, according to embodiments of the disclosure. The flow sensor 310 is similar to the flow sensor 200, except the flow sensor 310 does not include the third element 206 and the first resistor 228. Instead, the heater element 210 provides a signal indicative of the temperature of the heater element 210 to the control circuit 212.

The flow sensor 310 includes the substrate 244 with the first element 202 attached to the substrate 244 and situated to the left on the substrate 244 and the second element 204 attached to the substrate 244 and situated to the right on the substrate 244. The heater element 210 is attached to the substrate 244 and situated between the first element 202 and the second element 204, where the heater element 210 provides heat to the fluid above the first element 202, the heater element 210, and the second element 204. The fourth element 208 is situated in the upper portion of the substrate 244 and away from the heater element 210 for sensing the ambient temperature of the fluid in the flow sensor 310.

The flow sensor 310 is situated in a system, such as system 20, to detect fluid flow and to determine whether the system 20 has a fluid leak. The fluid flows through the flow sensor 310 from the left to the right or from the right to the left as indicated by arrows 312. If the system does not have a fluid leak, the fluid does not flow through the flow sensor 310, but is stagnant in the flow sensor 310. If the system does have a fluid leak, the fluid flows from left to right or from right to left through the flow sensor 310.

If the system has a fluid leak, the fluid enters the flow sensor 310 having an ambient temperature that is sensed by the fourth element 208. After the heater element 210 is activated, the heater element 210 provides a signal to the control circuit that indicates the temperature of the heater element 210. In some embodiments, a predetermined temperature difference is maintained between the ambient temperature of the fluid and the temperature of the heater element 210. In some embodiments, a predetermined temperature difference is maintained between the ambient temperature of the fluid and the temperature of the fluid adjacent the heater element 210. In some embodiments, the predetermined temperature difference is in a temperature of from 30 to 40 degrees Fahrenheit.

In one example operation, the fourth element 208 senses the ambient temperature of the fluid and provides a signal from the third output 238 to the control circuit 212 via communications path 242. The signal indicates the ambient temperature of the fluid, such as the ambient temperature of the fluid prior to any heating of the fluid by the heater element 210.

The control circuit 212 activates the heater element 210 by sending PWM signals to the gate of the MOSFET 222, which increases the temperature of the heater element 210 and the fluid adjacent the heater element 210. The heater element 210 provides an indication of the temperature of the heater element 210 to the control circuit 212.

The control circuit 212 receives the signals that indicate the ambient temperature of the fluid and the temperature of the heater element 210 or the temperature of the fluid adjacent the heater element 210. The control circuit 212 increases the temperature of the heater element 210 to a predetermined value or range of values above the ambient temperature. In some embodiments, the predetermined temperature difference is in a temperature of from 30 to 40 degrees Fahrenheit. The process of determining fluid flow continues as previously described in relation to the flow sensor 200.

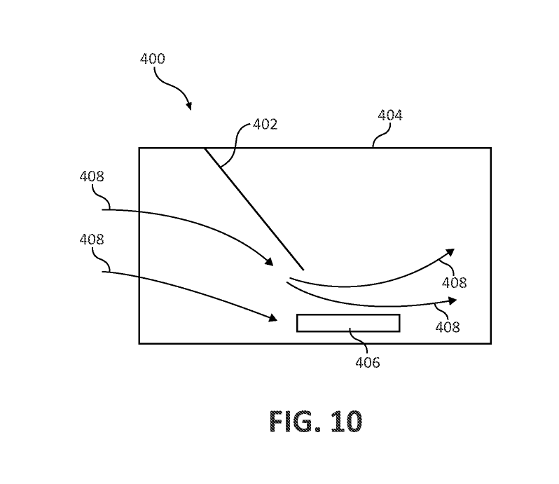

FIG. 10 is a diagram illustrating a flow sensor 400 that includes a baffle 402 in a flow sensor enclosure 404, according to embodiments of the disclosure. The flow sensor 400 can be similar to one of the flow sensors 100, 200, 300, and 310. The flow sensor 400 includes a substrate 406 that can be similar to one of the substrates 120 and 244 and that includes the components previously described in relation to the flow sensors 100, 200, 300, and 310.

The flow sensor 400 is situated in a system, such as system 20, to detect the flow of fluid and to determine whether the system 20 has a fluid leak. The fluid flows through the flow sensor 400 from left to right, as indicated by the arrows 408. The baffle 402 directs the fluid down and over the substrate 406, which concentrates the flow of the fluid over the substrate 406 for determining if the flow sensor 400 has a leak.

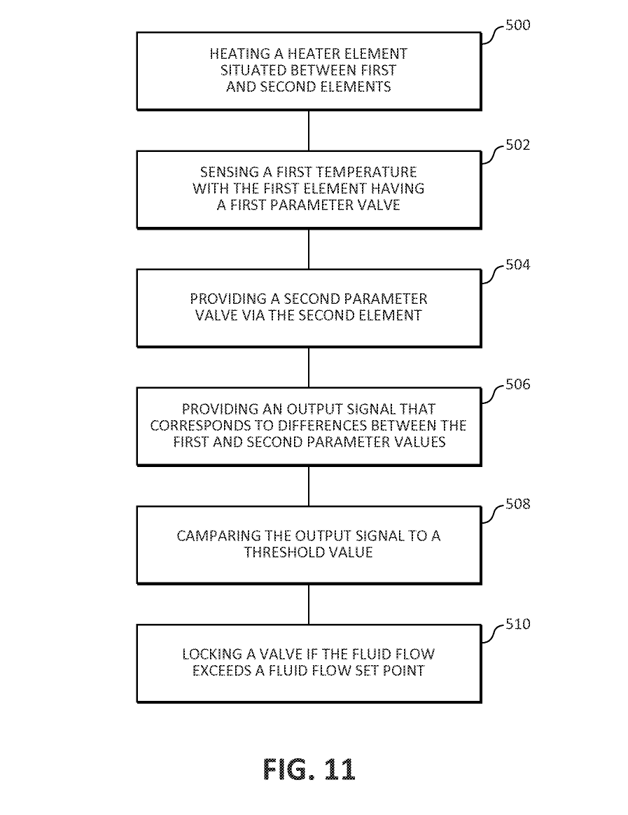

FIG. 11 is a method of detecting fluid flow in a flow sensor, such as one of the flow sensors 100, 200, 300, 310, according to embodiments of the disclosure. At 500, the method includes the step of heating a heater element situated between a first element and a second element to provide heat to a fluid. In some embodiments, a control circuit provides a signal to the heater element or to a transistor connected to the heater element to heat the heater element and the fluid. In some embodiments, the signal to the heater element is a PWM signal.

At 502, the method includes the step of sensing a first temperature of the fluid with the first element having a first parameter value that varies with the first temperature of the fluid adjacent the first element. At 504, the method includes the step of providing a second parameter value via the second element. At 506, the method includes the step of providing an output signal at an output that corresponds to differences between the first parameter value and the second parameter value. In some embodiments, the second parameter value of the second element is a fixed value. In some embodiments, the second parameter value of the second element varies with a second temperature of the fluid adjacent the second element, such that the second element senses the second temperature of the fluid adjacent the second element.

At 508, the method includes the step of comparing the output signal at the output to a threshold value that corresponds to a fluid flow set point to determine whether flow of the fluid, in at least one direction, across the first element, the heater element, and the second element exceeds the fluid flow set point. In some embodiments, this step of comparing includes comparing one input of a differential amplifier coupled to receive a voltage at the output to another input of the differential amplifier coupled to receive a threshold voltage as the threshold value, and providing an output signal that indicates whether the threshold value has been exceeded. In some embodiments the step of comparing includes receiving the output signal at the output at one input of a controller, comparing the received output signal to the threshold value, and providing a controller output signal that indicates whether the threshold value has been exceeded.

At 510, the method further includes the step of locking a valve to prevent fluid from flowing through the valve if flow of the fluid, in either direction, across the first element, the heater element, and the second element exceeds the fluid flow set point. In some embodiments, locking the valve includes preventing fluid from flowing through the valve to both a pilot and a burner. In some embodiments, the method includes the step of preventing ignition of the fluid by preventing a sparker from providing a spark for ignition of the fluid.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A system, comprising:
a first element to provide a first parameter value that varies with a first temperature of fluid adjacent the first element;
a second element to provide a second parameter value, the first element connected to the second element at an output such that output signals at the output correspond to differences between the first parameter value and the second parameter value;
a heater element situated between the first element and the second element to provide heat to the fluid; and
a circuit to evaluate the output signals at the output and a threshold value that corresponds to a fluid flow set point and to determine whether flow of the fluid, in at least one direction, across the first element, the heater element, and the second element exceeds the fluid flow set point.

2. The system of claim 1, wherein the second parameter value is a fixed value.

3. The system of claim 1, wherein the second parameter value varies with a second temperature of the fluid adjacent the second element.

4. The system of claim 1, wherein the circuit determines differences between the output signals and the threshold value, which indicates differences between the first parameter value and the second parameter value.

5. The system of claim 1, wherein one side of the first element is coupled to power and another side of the first element is connected, at the output, to one side of the second element, and another side of the second element is coupled to ground.

6. The system of claim 1, wherein the circuit includes a differential input having one input coupled to receive the output signals at the output and another input coupled to receive the threshold value, such that the differential input provides a signal that indicates whether the threshold value has been exceeded.

7. The system of claim 1, wherein the circuit provides a signal that indicates whether the fluid flow set point has been exceeded and comprising a valve that is locked via the signal from the circuit to prevent ignition of the fluid.

8. The system of claim 1, wherein the circuit provides a signal that indicates whether the fluid flow set point has been exceeded and comprising at least one of:
a valve and a controller that receive the signal from the circuit and provide a system shut-off signal to lock the valve and prevent ignition of the fluid.

9. The system of claim 1, wherein the circuit includes a controller having one input coupled to receive the output signals at the output and the controller compares the output signals at the output to the threshold value and provides a signal that indicates whether the threshold value has been exceeded.

10. The system of claim 9, comprising a valve that is locked via the signal from the controller to prevent ignition of the fluid.

11. The system of claim 1, comprising:
a third element to provide a third parameter value that varies with a second temperature of the fluid adjacent the third element to measure at least one of ambient temperature of the fluid and heater temperature of the heater element.

12. The system of claim 11, comprising:
a controller to receive signals indicating differences between the ambient temperature and the heater temperature and to provide heater signals to the heater element to maintain a temperature difference between the ambient temperature and the heater temperature.

13. The system of claim 1, comprising:
a third element to provide a third parameter value that varies with a second temperature of the fluid adjacent the third element to measure ambient temperature of the fluid; and
a controller to receive signals indicating differences between the third temperature and a heater temperature and to provide heater signals to the heater element to maintain the differences between the third temperature and the heater temperature in a predetermined range.

14. The system of claim 13, comprising a fourth element to provide a fourth parameter value that varies with a third temperature of the fluid adjacent the fourth element to measure the heater temperature of the heater element.

15. The system of claim 13, wherein the heater element provides a heater signal or a heater parameter that indicates a heater temperature.

16. A system comprising:
a first element to provide a first parameter that varies with a first temperature of fluid adjacent the first element to measure upstream temperature of the fluid;
a second element to provide a second parameter that varies with a second temperature of the fluid adjacent the second element to measure downstream temperature of the fluid;
a heater element situated between the first element and the second element to provide heat to the fluid; and
a controller to receive signals indicating differences between the first temperature and the second temperature, the controller to determine whether flow of the fluid across the first element, the heater element, and the second element exceeds a fluid flow set point.

17. The system of claim 16, comprising:
a third element to provide a third parameter that varies with a third temperature of the fluid adjacent the third element to measure at least one of ambient temperature of the fluid and heater temperature of the heater element, wherein the controller receives signals indicating differences between the ambient temperature and the heater temperature and the controller provides heater signals to the heater element to maintain a predetermined difference between the ambient temperature and the heater temperature.

18. The system of claim 17, wherein the predetermined difference is a range of from 30 to 40 degrees Fahrenheit.

19. The system of claim 17, comprising a fourth element to provide a fourth parameter that varies with a fourth temperature of the fluid adjacent the fourth element to measure the heater temperature of the heater element.

20. The system of claim 17, wherein the heater element provides a heater signal or a heater parameter that corresponds to the heater temperature.

21. The system of claim 16, wherein the controller has one input coupled to receive an output signal that corresponds to the differences between the first temperature and the second temperature and the controller compares the output signal to a threshold value to determine whether flow of the fluid, in either direction, across the first element, the heater element, and the second element exceeds a fluid flow set point.

22. The system of claim 16, comprising a differential amplifier having one input coupled to receive a voltage that corresponds to the differences between the first temperature and the second temperature and another input coupled to receive a threshold voltage as the threshold value, such that the differential amplifier provides a signal that indicates whether the threshold value has been exceeded.

23. A method comprising:
heating a heater element situated between a first element and a second element to provide heat to a fluid;
sensing a first temperature of the fluid with the first element having a first parameter value that varies with the first temperature of the fluid adjacent the first element;
providing a second parameter value via the second element;
providing an output signal at an output that corresponds to differences between the first parameter value and the second parameter value; and
comparing the output signal at the output to a threshold value that corresponds to a fluid flow set point to determine whether flow of the fluid, in at least one direction, across the first element, the heater element, and the second element exceeds the fluid flow set point.

24. The method of claim 23, comprising:
sensing a second temperature of the fluid with the second element having the second parameter value that varies with the second temperature of the fluid adjacent the second element.

25. The method of claim 23, wherein comparing comprises:
comparing one input of a differential amplifier coupled to receive the output signal at the output to another input of the differential amplifier coupled to receive a threshold value; and
providing an amplifier output signal that indicates whether the threshold value has been exceeded.

26. The method of claim 23, wherein comparing comprises:
receiving the output signal at the output at one input of a controller;
comparing the output signal at the output to the threshold value; and
providing a controller output signal that indicates whether the threshold value has been exceeded.

27. The method of claim 23, comprising:
locking a valve to prevent fluid from flowing through the valve if flow of the fluid, in either direction, across the first element, the heater element, and the second element exceeds the fluid flow set point.
